(19) United States
(12) Patent Application Publication
(10) Pub. No.: US 2009/0188152 A1
(43) Pub. Date: Jul. 30, 2009

(54) Live bait keeper system

(76) Inventor: Denis J. Davin, Pittsburgh, PA (US)

Correspondence Address: MCKAY & ASSOCIATES, PC., 801 MCNEILLY ROAD, PITTSBURGH, PA, 15226, US

(21) Appl. No.: 12/356,595

(22) Filed: Jan. 21, 2009

Related U.S. Application Data
(60) Provisional application No. 61/024,571, filed on Jan. 30, 2008.

(51) Int. Cl. A01K 97/05

(52) U.S. Cl. 43/56

(57) ABSTRACT

Described is a live bait keeper system having a housing. The housing has a plurality of housing holes defined at its bottom. A pump is situated in the interior of the housing. A power cord is attached to the pump, traveling from the housing for connection to a shore or dock-located power supply. A hose has a proximal end and a distal discharge end. The proximal end is attached to the pump and the discharge end is adapted to be placed in a livewell of a boat. A lid is utilized for the housing and has defined thereon a plurality of lid holes. A rope is attached to the handle of the housing, wherein the housing with the pump and the lid can be lowered and maintained within a body of water for pumping the water into the livewell.

### SPECIFIC REFERENCE

This application claims benefit of provisional application Ser. No. 61/024,571, filed Jan. 30, 2008.

### BACKGROUND

The instant invention relates to systems for keeping fishing bait alive during periods when the fishing vessel is not in use. In particular, the present invention utilizes a pump and housing arrangement which can maintain live bait in the livewell of the vessel when the livewell of that vessel cannot be operated by the vessels on-board systems, for instance when the boat is docked overnight and un-powered.

The typical livewell on a boat is well-suited to maintain live bait, but only while the vessel's battery is powered on. Water is pumped into the livewell from the ocean by means of a battery-operated pump located on the boat. Typically the livewell has an overflow drain so that water is pumped into the livewell and drained from the overflow as a means to circulate fresh, oxygenated seawater into the livewell. However, the boat pump cannot be used overnight because the battery would drain. Furthermore, the life of the vessel's on-board pump would be shortened from constant use. Without an effective means to recirculate seawater during long resting periods, the bait in the livewell will die.

### SUMMARY

The instant invention comprehends a live bait keeper system, comprising a housing having a top, a bottom, a handle, and an interior. The housing has a plurality of housing holes defined at the bottom. A pump is situated in the interior of the housing. A power cord is attached to the pump, traveling from the housing for connection to a shore or dock-located power supply. A hose has a proximal end and a distal discharge end. The proximal end is attached to the pump and the discharge end is adapted to be placed in a livewell of a boat. A lid is utilized for the housing and has defined thereon a plurality of lid holes. A rope is attached to the handle of the housing, wherein the housing with the pump and the lid can be lowered and maintained within a body of water for pumping the water into the livewell.

### BRIEF DESCRIPTION OF THE DRAWINGS

FIG. 1 shows a perspective view of the instant invention with the lid in place.

FIG. 2 shows a top view of the instant invention with the lid in place.

FIG. 3 shows a top view of the instant invention showing the interior and bottom.

FIG. 4 shows a perspective view of the instant invention in use with a boat.

FIG. 5 shows a perspective view of the instant invention detailing a location of the power cord.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated kit assembly, and such further applications of the principles of the invention illustrated herein, as would normally occur to persons skilled in the art to which the invention relates. This detailed description of this invention is not meant to limit the invention, but is meant to provide a detailed disclosure of the best mode of practicing the invention.

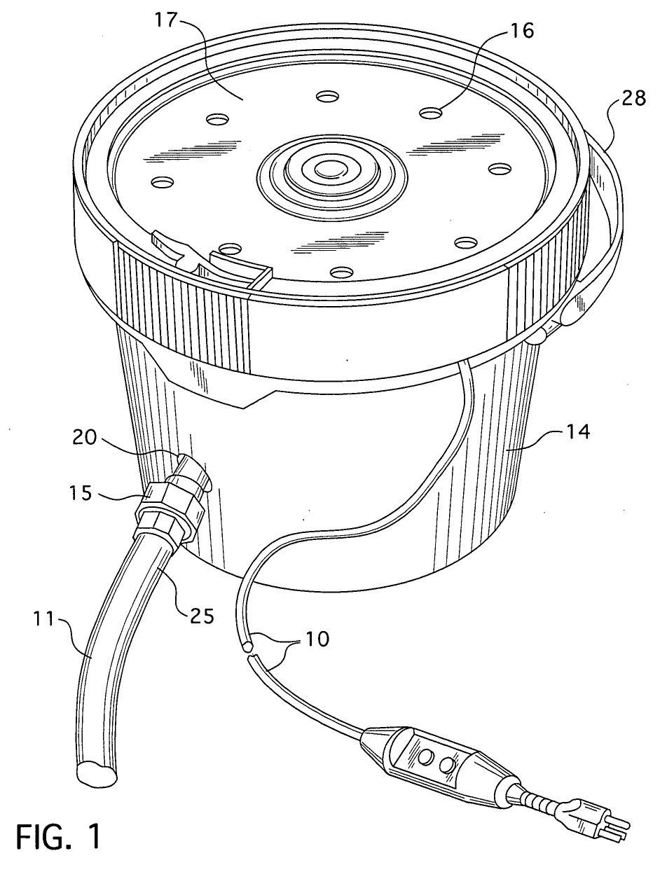

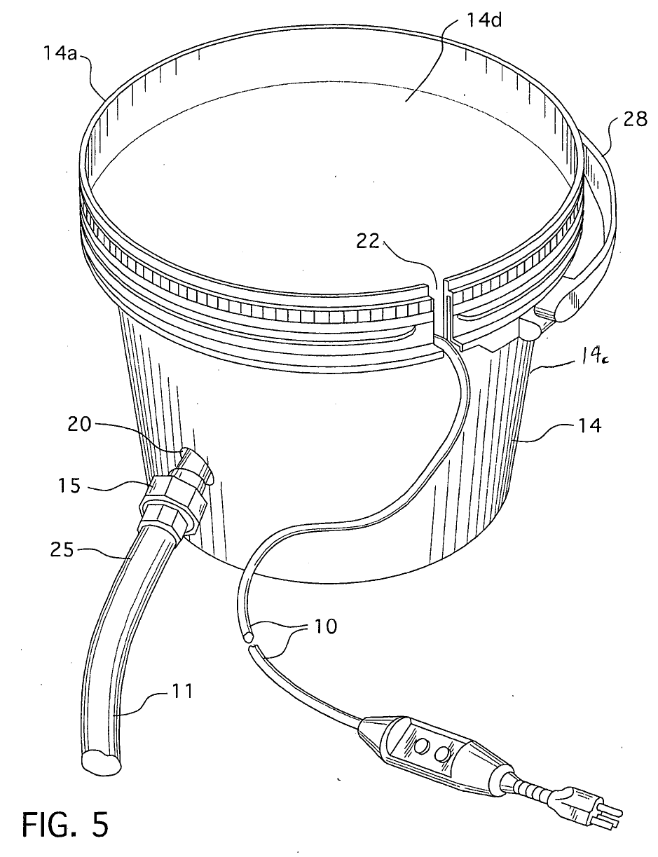

With reference then to FIGS. 1-5, a submersible saltwater capable electric pump 18 having an outlet 13 is mounted in the interior 14d of housing 14. Although not limited thereto, the pump 18 for example can be a 110 volt AC pump 18 with a power cord 10. In the preferred embodiment the pump capacity can output six-hundred to one-thousand gallons per hour, but this can also vary depending on the size of the livewell and other factors.

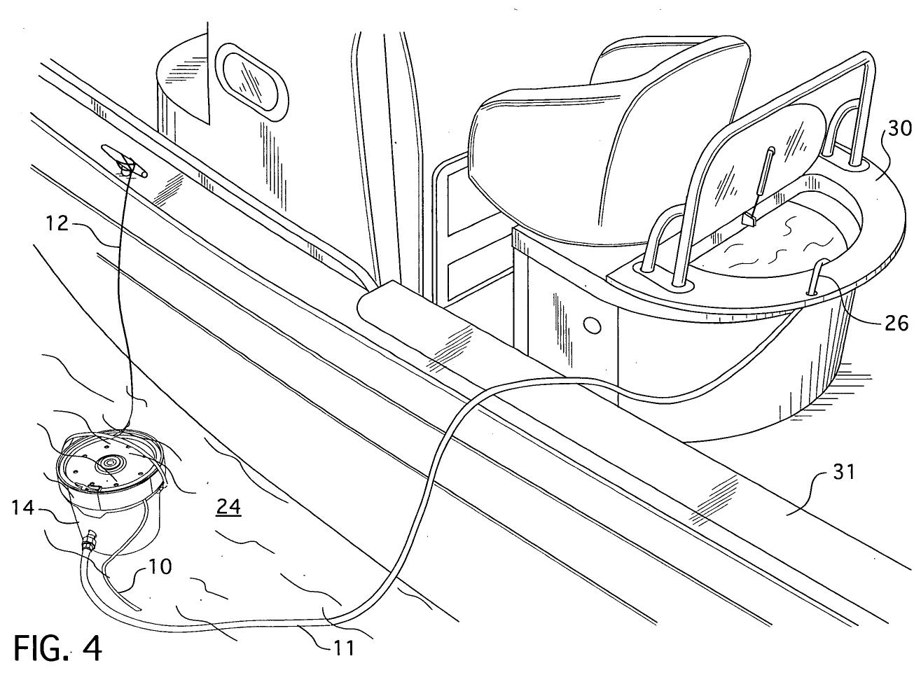

The housing 14 is preferably a cylindrical container with lid 17, for instance made of lightweight composite or plastic. Housing 14 has a bottom 14b, a top 14a, a side 14c, and an interior 14d. Housing holes 16a are defined at the bottom 14b of housing 14, for instance surrounding pump 18. Spaced holes 16 are further defined through lid 17. The housing 14 further includes an attached and detachable rope 12 or cord which allows the housing 14 and its internal system components to be removably attached and hung from the side of the boat down into the water, as further shown by FIG. 4 and as will be further described.

As above, the bottom 14b of the housing 14 is predrilled with housing holes 16a. Each housing hole 16a can be ½″ diameter for example and can number approximately six to thirty six and be evenly spaced. The number of housing holes 16a may vary depending on the pump capacity. Importantly, by utilizing the plurality of housing holes 16a and also the spaced holes 16 on lid 17 (or even the side of housing if desired), the housing 14 is adapted to act as a large sediment filter to protect the pump 18 from debris and resulting clogs and damage. Critically as well, the housing 14 also enables the convenient storage and transport of the system components since the discharge hose 11 and power cord 10 can both be stored inside of the housing 14 and quickly removed from the housing 14 for use.

Pump 18 has a pump outlet 13 extending through a brass nipple 19 disposed through a side hole 20 defined in the side 14c of the housing 14 towards the bottom 14b thereof. The brass nipple 19 for instance is approximately 2″ in length to extend past the exterior of housing. A solid brass union 15 is then attached to the outer end of brass nipple 19 to act as a quick disconnect for the discharge hose 11. Discharge hose 11 has a discharge end 26 and a proximal end 25 relative to pump outlet 13 such that proximal end 25 connects to the brass union 15 and the discharge end 26 will travel to the live well 30 of boat 31.

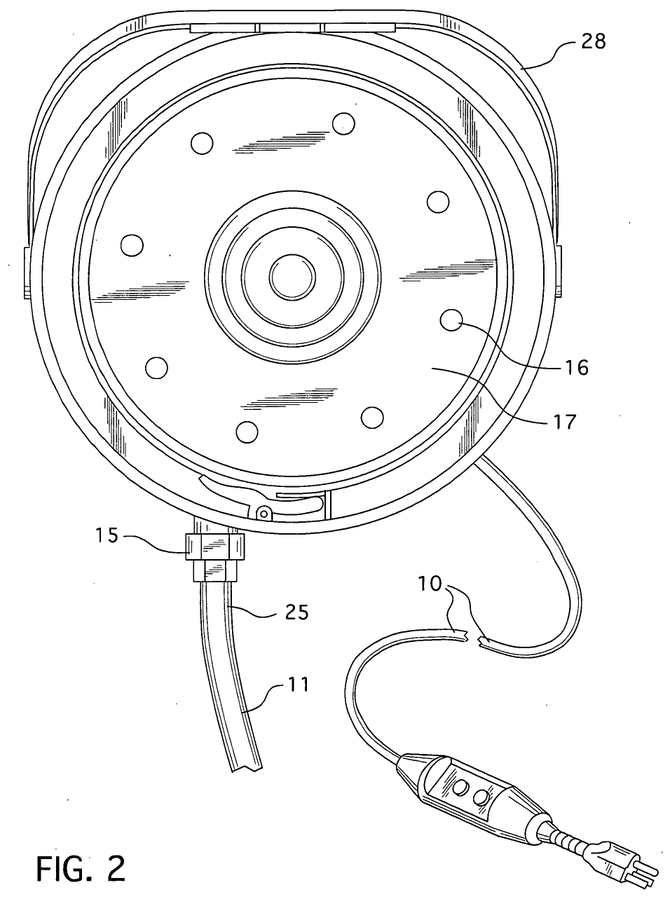

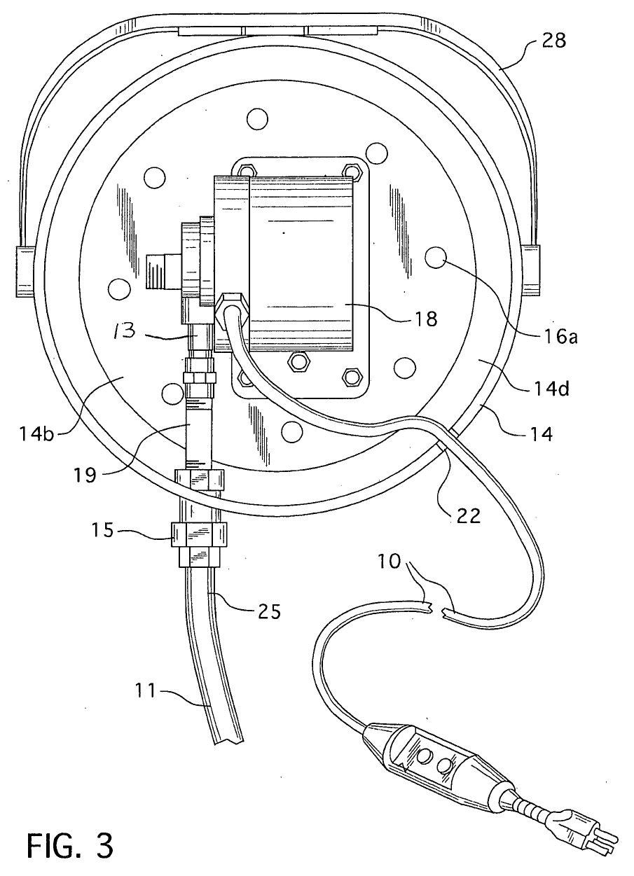

Accordingly, pump outlet 13 is connected to one end of the brass nipple 19 component. A brass union 15 is connected to the other end of brass nipple 19. Proximal end 25 of discharge hose 11 is fitted to the brass union 15. The power cord 10 is extended and fitted through a slot 22 located in the lid 17 or near the top of the housing 14. The lid 17 is then securely attached to the housing 14. One end of the rope 12 is then attached to the housing 14 or an accompanying handle 28. The other end of rope 12 is attached to the boat 31, for instance at one of the cleats, and the housing 14 is lowered into the water 24 and suspended into the water 24, preferably approximately one foot. Relative to the housing, the distal discharge end 26 of the outlet hose 11 is extended and inserted into the livewell 30 of the boat, and the power cord 10 is then plugged into a 110 volt GFI protected outlet situated at the shore or dock, i.e. a shore or dock-located power supply. The power cord 10 itself may also be GFCI (ground fault current interrupter) protected as shown by FIGS. 2 and 3.

Upon actuation, saltwater is pumped into the livewell 30 to keep bait stored therein alive even during periods when the boat is powered off and docked. After use the pump 18 is unplugged, the discharge hose 11 is disconnected and all components are flushed with freshwater. The discharge hose 11 and power cord 10 are recoiled and stored neatly inside of the housing 14 for future use.

I claim:

1. A bait keeper system, comprising:
a housing having a top, a bottom, a handle, a side, and an interior, said housing having a plurality of housing holes defined therein;
a pump situated in said interior;
a power cord attached to said pump traveling from said housing for connection to a shore or dock-located power supply;
a hose having a proximal end and a distal discharge end, said proximal end attached to said pump and said discharge end adapted to be placed in a livewell of a boat;
a lid for said housing, said lid having defined therethrough a plurality of spaced holes, wherein in combination said housing holes and said spaced holes act as a sediment filter for said pump; and,
a rope attached to said handle of said housing, wherein said housing with said pump and said lid can be lowered and maintained within a body of water for pumping said water into said livewell.

2. The bait keeper system of claim 1, wherein said pump is centered within said interior at said bottom of housing with said housing holes evenly spaced around said pump.

3. The bait keeper system of claim 1, further comprising a brass nipple extending from said pump to the exterior of said housing through a side hole defined in said housing.

4. The bait keeper system of claim 3, further comprising a brass union attached to said brass nipple such that said proximal end of said hose can connect to said pump outside of said housing.

5. The bait keeper system of claim 1, further comprising a slot defined at said top of said housing through which said power cord can travel.

6. The bait keeper system of claim 1, wherein said power cord is GFCI protected.

7. The bait keeper system of claim 1, wherein said power supply is GFCI protected.
